(19) United States
(12) Patent Application Publication
(10) Pub. No.: US 2025/0190451 A1
(43) Pub. Date: Jun. 12, 2025

(54) INFORMATION PROCESSING APPARATUS, METHOD, AND STORAGE MEDIUM

(71) Applicant: KABUSHIKI KAISHA TOSHIBA, Tokyo (JP)

(72) Inventors: Shintaro YAMAMOTO, Kawasaki Kanagawa (JP); Jumpei ANDO, Yokohama Kanagawa (JP); Wataru WATANABE, Tokyo (JP); Toshiyuki ONO, Kawasaki Kanagawa (JP)

(73) Assignee: KABUSHIKI KAISHA TOSHIBA, Tokyo (JP)

(21) Appl. No.: 18/773,876

(22) Filed: Jul. 16, 2024

(30) Foreign Application Priority Data
Dec. 6, 2023 (JP) 2023-206089

(51) Int. Cl. G06F 16/28; G06F 16/22

(52) U.S. Cl. CPC G06F 16/285; G06F 16/2237

(57) ABSTRACT

According to one embodiment, an information processing apparatus includes processing circuitry. The processing circuitry is configured to acquire data including a variable name and a value associated with the variable name, and a correspondence relationship between the variable name and the value. The processing circuitry is configured to generate a variable name vector corresponding to each variable name and a value vector corresponding to the value associated with each variable name. The processing circuitry is configured to combine the variable name vector and the value vector based on the correspondence relationship.

### CROSS-REFERENCE TO RELATED APPLICATION

This application is based upon and claims the benefit of priority from Japanese Patent Application No. 2023-206089, filed Dec. 6, 2023, the entire contents of which are incorporated herein by reference.

### FIELD

Embodiments described herein relate generally to an information processing apparatus, a method, and a storage medium.

### BACKGROUND

With the development of Internet of Things (IoT) technology, an information processing apparatus can acquire various data such as multivariate data represented by tabular data. Here, the multivariate data is data obtained by aggregating data having different properties, and is used in many situations. For example, at a manufacturing site, multivariate data obtained by aggregating manufacturing data related to manufacturing conditions such as material names and apparatus names used for manufacturing and product states such as inspection data of the manufactured products is used. In addition, in the medical field, multivariate data obtained by aggregating medical data regarding patients such as attribute information of the patients and various examination values is used.

In addition, by analyzing these pieces of multivariate data, it is expected to obtain an analysis result such as product or apparatus failure or possible diseases. For example, in a case of analyzing tabular data which is a type of multivariate data, various machine learning techniques for performing classification or regression are used as tabular data analysis techniques. Here, the tabular data has a value of each variable corresponding to one sample along the row direction, and stores one variable name and a value of each sample corresponding the variable name along the column direction. Each variable includes a variable name and a value thereof. Since this type of tabular data analysis technique is based on a premise that the column configuration of tabular data at the time of learning is the same as the column configuration at the time of operation, only data having the same column configuration as the training data at the time of learning can be analyzed at the time of operation.

However, in a case where the tabular data is analyzed, the column configuration of the tabular data at the time of operation may be different from the column configuration of the training data at the time of learning. For example, in a case where tabular data is manufacturing data, variables constituting the manufacturing data may change between the time of learning and the time of operation due to a change in a manufacturing process, addition or reduction of inspection items, or the like. In this case, the tabular data analysis technique cannot analyze the manufacturing data in which the column configuration has been changed due to the change, addition, or reduction of the variable name. For this reason, in the tabular data analysis technique, it is needed to perform relearning with the training data after the column configuration is changed, or to extract only the common column from the manufacturing data before and after the change of the column configuration and perform analysis. In the latter case, the remaining columns after extraction are not used for analysis and are abandoned (ignored).

Therefore, it is desired to be able to analyze data in which a variable name has been changed, added, or reduced. As described above, in a case where data in different column configurations can be analyzed, effects of enabling training-data augmentation, eliminating a need for relearning, and the like are expected.

### BRIEF DESCRIPTION OF DRAWINGS

FIG. 1 is a block diagram illustrating an example of a configuration of an information processing apparatus according to a first embodiment.

FIG. 2 is a flowchart for explaining an operation according to the first embodiment.

FIG. 3 is a schematic diagram for explaining the operation according to the first embodiment.

FIG. 4 is a schematic diagram for explaining the operation according to the first embodiment.

FIG. 5 is a schematic diagram for explaining a modification of the first embodiment.

FIG. 6 is a block diagram illustrating an example of a configuration of an information processing apparatus according to a second embodiment.

FIG. 7 is a flowchart for explaining an operation according to the second embodiment.

FIG. 8 is a schematic diagram for explaining the operation according to the second embodiment.

FIG. 9 is a block diagram illustrating an example of a configuration of an information processing apparatus according to a third embodiment.

FIG. 10 is a flowchart for explaining an operation according to the third embodiment.

FIG. 11 is a schematic diagram for explaining the operation according to the third embodiment.

FIG. 12 is a block diagram illustrating an example of a hardware configuration of an information processing apparatus according to a fourth embodiment.

### DETAILED DESCRIPTION

In general, according to one embodiment, an information processing apparatus includes processing circuitry. The processing circuitry is configured to acquire data including a variable name and a value associated with the variable name, and a correspondence relationship between the variable name and the value. The processing circuitry is configured to generate a variable name vector corresponding to each variable name and a value vector corresponding to the value associated with each variable name. The processing circuitry is configured to combine the variable name vector and the value vector based on the correspondence relationship.

Hereinafter, each embodiment will be exemplarily described with reference to the drawings. In the following description, tabular data stored in a csv file or the like will be described as an example of multivariate data in which variable names and values are associated with each other. However, not limited thereto, data in a file format in which a variable name and a value are associated, such as json and yaml, may be used as the multivariate data.

### First Embodiment

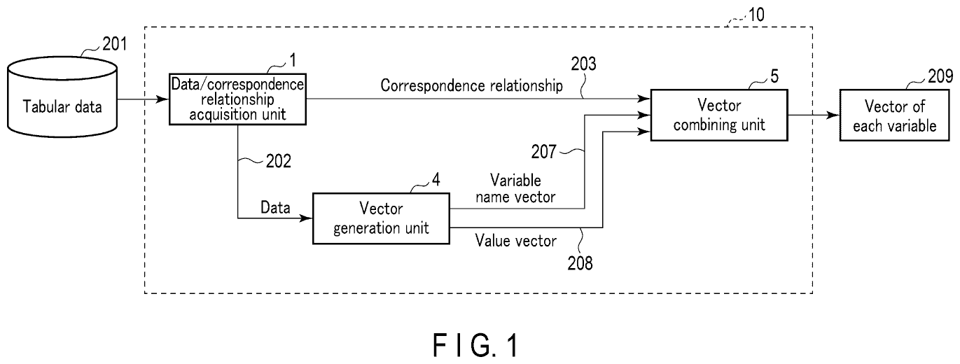

FIG. 1 is a block diagram illustrating an example of a configuration of an information processing apparatus according to a first embodiment. An information processing apparatus 10 includes a data/correspondence relationship acquisition unit 1, a vector generation unit 4, and a vector combining unit 5.

Here, the data/correspondence relationship acquisition unit 1 receives input of tabular data 201 that is a type of multivariate data. Here, the multivariate data is data obtained by aggregating data having different properties, and is collected for a plurality of samples. For example, the tabular data 201 may store data in a plurality of cells (0≤i≤m−1, 0≤j≤n−1) of m rows and n columns. For example, a plurality of variable names arranged in a plurality of columns (i=0, 1≤j≤n−1) after the first column in the 0th row, a plurality of sample IDs arranged in a plurality of rows (1≤i≤m−1, j=0) after the first row in the 0th column, and a plurality of values arranged in a plurality of cells (1≤i≤m−1, 1≤j≤m−1) after the first row and the first column may be stored in association with each other. In such a case, the tabular data 201 has a plurality of variables in a sample along the row direction, and each of the variables has a variable name (column name) and a value corresponding to the variable name along the column direction. Note that the sample ID is not essential and may be omitted. For example, in a case where the sample is anonymous as in big data, the sample ID can be omitted. The variables may be independent of each other or may be related to each other. As the value associated with the variable name, data in an arbitrary data format can be used as appropriate. For example, the value may be any of a discrete categorical value, text data, and a continuous value represented by a numerical value. In addition, the data/correspondence relationship acquisition unit 1 acquires, from the tabular data 201, data 202 including a variable name and a value associated with the variable name, and a correspondence relationship 203 between the variable name and the value.

The vector generation unit 4 generates a variable name vector 207 corresponding to each variable name and a value vector 208 corresponding to a value associated with each variable name. For example, in a case where the value is a categorical value, the value vector 208 is a vector corresponding to the categorical value. In a case where the value is a categorical value or sentence data, the vector generation unit 4 may perform text analysis on the value to generate the value vector 208 that is a sentence vector. Furthermore, for example, in a case where the value is a numerical value, the value vector 208 is a vector corresponding to the numerical value. In this case, the vector generation unit 4 may, for example, input a numerical value to a neural network to generate the value vector 208 as an output of the neural network. Furthermore, for example, the vector generation unit 4 may generate the value vector 208 by linearly transforming a numerical value.

The vector combining unit 5 combines the variable name vector 207 and the value vector 208 based on the correspondence relationship 203 between variable names and values. For example, the vector combining unit 5 may combine the variable name vector 207 and the value vector 208 using a sum of the variable name vector 207 and the value vector 208 related to a same variable name. Furthermore, for example, the vector combining unit 5 may combine the variable name vector 207 and the value vector 208 by arranging respective elements of the variable name vector 207 and the value vector 208 related to a same variable name. Furthermore, for example, the vector combining unit 5 may output a vector 209 obtained by combining the variable name vector 207 and the value vector 208 by inputting the variable name vector 207 and the value vector 208 related to a same variable name to a neural network. The vector 209 is a vector 209 of each variable output by the number of variable names (the number of columns).

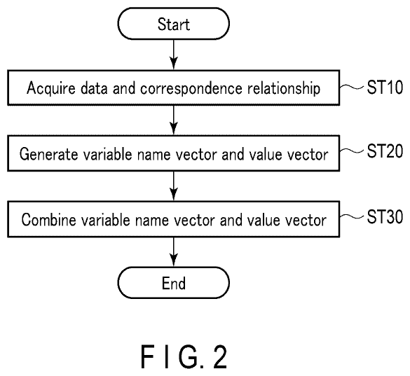

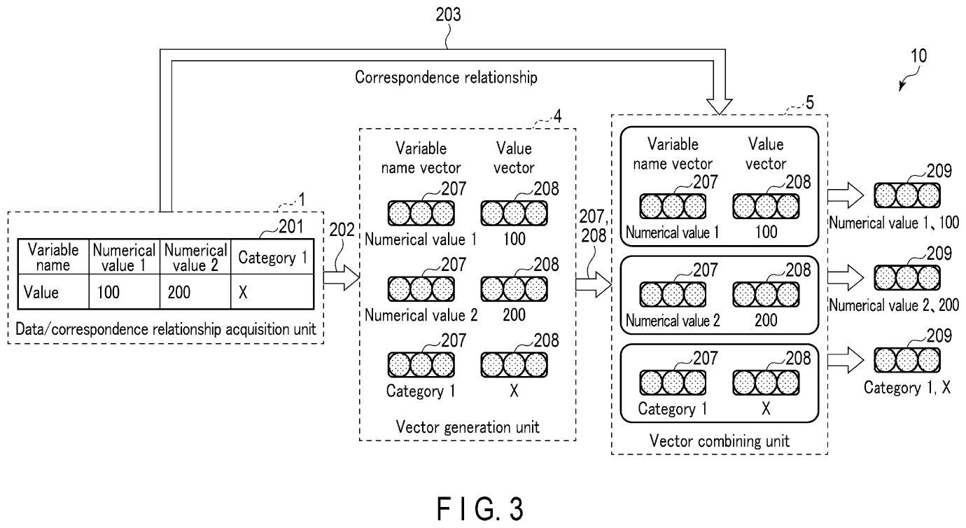

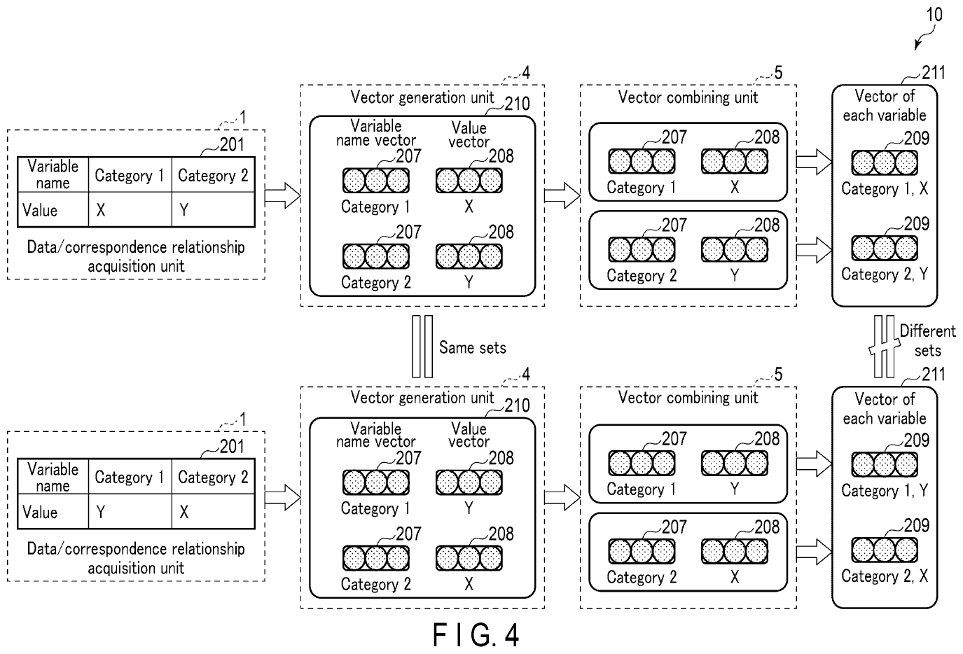

Next, the operation of the information processing apparatus having the above configuration will be described with reference to the flowchart of FIG. 2 and the schematic diagrams of FIGS. 3 and 4.

### (Step ST10: Acquisition of Data and Correspondence Relationship)

As illustrated in FIGS. 2 and 3, the data/correspondence relationship acquisition unit 1 receives input of tabular data 201. The tabular data 201 has three variables (numerical values 1, 100), (numerical values 2, 200), and (category 1, X) in a sample along the row direction, and each of the variables has a variable name (column name) and a value associated with the variable name along the column direction. In addition, the data/correspondence relationship acquisition unit 1 acquires, from the tabular data 201, data 202 including a variable name and a value associated with the variable name, and a correspondence relationship 203 between the variable name and the value.

### (Step ST20: Vector Generation)

The vector generation unit 4 generates variable name vector 207 corresponding to each of variable names “numerical value 1”, “numerical value 2”, and “category 1” based on data 202. The vector generation unit 4 also generates a value vector 208 corresponding to the values “100”, “200”, and “X” associated with each variable name. In a case where input data is N number of variables (N number of columns), the vector generation unit 4 generates N number of variable name vectors 207 obtained from N number of variable names and N number of value vectors obtained from values associated with the respective variable names. In FIG. 3, N=3.

The variable name can be regarded as text data. As a method of vectorization of a variable name, there is a method of learning an embedding vector. In this method, a vocabulary list is created from variable names appearing in training data, and an embedding vector corresponding to each vocabulary is learned. In addition, the variable name may be divided into tokens, and the embedding vector may be learned for each token. In this case, token vectors of the number of tokens constituting the variable name are obtained from one variable name. The variable name vector 207 may be generated by averaging token vectors obtained from the respective tokens constituting the variable name. In addition, regarding the variable name vector 207, the variable name vector 207 may be generated by inputting a set of token vectors constituting a variable name to the neural network. By performing the token division, it is possible to expect an effect that variable name vectors obtained from similar variable names including the same token are similar to each other. In addition, in a case where an unknown variable name appears at the time of inference, an embedding vector learned from another variable name including a token constituting the variable name may be used.

For the value corresponding to the variable name, the vector acquisition method is changed according to the type of data. In a case where the value is a categorical value or text data, it can be vectorized by the same processing as the variable name. The embedding vector to be learned may be common to that of the variable name. By sharing the embedding vector with the variable name, embedding vectors of various tokens can be learned. For example, in a case where a token that is not included in the variable name in the training data is included in the value, embedding can be learned from the token constituting the value, and a variable name vector can be generated even if the input is unknown as the variable name. In addition, there is a case where sentence data is stored in a value of the tabular data 201. In this case, the value may be vectorized using a feature vector extractor for a sentence which is a technique of natural language processing.

In a case where the value corresponding to the variable name is a numerical value, vectorization is performed by processing different from the case of categorical values and text data. For example, the value vector 208 may be generated by linearly transforming a numerical value. Specifically, for example, the value vector 208 may be generated by multiplying a numerical value by a weight matrix. In a case where the output value vector 208 has a Dₙᵤₘ dimension, the size of the weight matrix Wₙᵤₘ is 1×Dₙᵤₘ dimension since scalar values are stored in each variable. In a case where the value vector 208 is vₙᵤₘ and the original numerical value is xₙᵤₘ, the bias bₙᵤₘ of the Dₙᵤₘ dimension is added, and the value vector vₙᵤₘ is expressed as follows.

vₙᵤₘ=xₙᵤₘ·Wₙᵤₘ+bₙᵤₘ

Here, the weight matrix Wₙᵤₘ and the bias bₙᵤₘ are determined by learning. Similarly, the value vector 208 may be acquired from a numerical value by a neural network having a multilayer conversion process. In addition, a numerical value may be vectorized by a method described in a technical literature (Yury Gorishniy, Ivan Rubachev, Artem Babenko “On Embeddings for Numerical Features in Tabular Deep Learning” Advances in Neural Information Processing Systems 35, pages 24991-25004, 2022). In addition, vectorization may be performed by a method similar to the categorical value by regarding a numerical value as a character string.

### (Step ST30: Vector Combining)

The vector combining unit 5 combines the variable name vector 207 and the value vector 208 based on the correspondence relationship 203 between the variable name and the value in each variable, and acquires the vector 209 corresponding to each variable. Here, in a case where the input data to the information processing apparatus 10 is N variables, the vector combining unit 5 acquires and outputs N number of D-dimensional vectors 209. In the example of FIG. 3, in a case where the tabular data 201 has three variables, three D-dimensional vectors 209 are output.

Specifically, the vector combining unit 5 receives two vectors, a variable name vector 207 and a value vector 208, as an input, and outputs a D-dimensional vector 209 using a sum of the two vectors. In this case, the variable name vector 207 and the value vector 208 are both D-dimensional. Note that, not limited thereto, the variable name vector 207 and the value vector 208 may have different dimensions. For example, it is assumed that the variable name vector 207 is represented by v_{variable}, a variable name vector v_{variable} is a D_{variable} dimension, the value vector 208 is represented by vᵥₐₗᵤₑ, and a value vector vᵥₐₗᵤₑ is a Dᵥₐₗᵤₑ dimension. A vector 209 of each variable is represented by v. Here, as described below, a vector v in which elements of a variable name vector v_{variable} and elements of a value vector vᵥₐₗᵤₑ are arranged may be a D_{variable}+Dᵥₐₗᵤₑ dimensional vector corresponding to each variable.

v_{variable}=[v_{variable}¹,v_{variable}², . . . ,v_{variable}^{D}^{_{variable}},]

vᵥₐₗᵤₑ=[vᵥₐₗᵤₑ¹,vᵥₐₗᵤₑ², . . . , vᵥₐₗᵤₑ^{D}^{ᵥₐₗᵤₑ}]

v=[v_{variable}¹,v_{variable}², . . . ,v_{variable}^{D}^{_{variable}},vᵥₐₗᵤₑ¹,vᵥₐₗᵤₑ², . . . ,vᵥₐₗᵤₑ^{D}^{ᵥₐₗᵤₑ}]

Furthermore, the vector combining unit 5 may perform linear transformation on the vector v that is the D_{variable}+Dᵥₐₗᵤₑ dimensional vector, and use the obtained D-dimensional vector as the vector 209.

In any case, the vector combining unit 5 performs a combining process of acquiring each vector 209 corresponding to each variable from the variable name vector 207 and the value vector 208. By performing such a combining process, in each vector 209, the correspondence relationship between the variable name and the value of the input data can be made explicit.

As described above, according to the first embodiment, the data/correspondence relationship acquisition unit 1 acquires, from the tabular data 201, the data 202 including the variable name and the value associated with the variable name and the correspondence relationship 203 between the variable name and the value. The vector generation unit 4 generates a variable name vector 207 corresponding to each variable name and a value vector 208 corresponding to a value associated with each variable name. The vector combining unit 5 combines the variable name vector 207 and the value vector 208 based on the correspondence relationship 203 between variable names and values. As described above, with the configuration in which the variable name vector 207 corresponding to each variable name and the value vector 208 corresponding to the value associated with each variable name are combined, regarding the data in which the variable name and the value are associated with each other, even if the variable name is changed, added, or reduced, the data can be analyzed.

This effect will be described with reference to a technical literature (Zifeng Wang and Jimeng Sun “TransTab: Learning Transferable Tabular Transformers Across Tables” Advances in Neural Information Processing Systems 35, pages 2902-2915, 2022. (hereinafter, referred to as [Wang22])) as a comparative example. The technical literature [Wang22] of the comparative example proposes a technique capable of handling tabular data having different column configurations by converting constituent elements of tabular data into a set of vectors. In this type of comparative example, a column name (variable name) and a categorical value of tabular data are divided into tokens, and each token is vectorized. At that time, in the comparative example, information indicating which of the column name and the categorical value each token is derived from and which column each token belongs to is lost. Therefore, in the comparative example, the correspondence relationship between the column name and the value is lost, and it is difficult to distinguish in a case where the same categorical value is used in different columns. Therefore, in the comparative example, it is not possible to identify which column each categorical value belongs to, and there is a disadvantage that appropriate processing cannot be performed.

On the other hand, according to the first embodiment, it is possible to explicitly distinguish which variable name a value corresponds to, by acquiring the correspondence relationship 203 between a variable name and a value, generating vectors respectively corresponding to the variable name and the value, and combining the variable name vector 207 and the value vector 208 using the correspondence relationship 203. In addition to the above, according to the first embodiment, as illustrated in the upper and lower stages of FIG. 4, a set 210 of vectors having the variable name vector 207 and the value vector 208 generated by the vector generation unit 4 as elements is the same set between the two samples. Even in this case, according to the first embodiment, the set 211 having the two vectors 209 output from the vector combining unit 5 as elements is the set 211 different from each other between the two samples. According to the first embodiment, it is possible to distinguish and process the set 211 of vectors 209 obtained from two samples.

Therefore, in the case of tabular data using the same categorical value for a plurality of columns between two samples, in the comparative example, different samples cannot be distinguished because a correspondence relationship between a column name and a value is lost. In addition, since the comparative example corresponds to a configuration without the vector combining unit 5 in FIG. 4, the same set 210 is obtained between two samples. In such a comparative example, a set 210 of vectors obtained from two samples cannot be distinguished by subsequent processing.

On the other hand, according to the first embodiment, different samples can be distinguished in order to maintain the correspondence relationship between the column name (variable name) and the value. In other words, since the first embodiment includes the vector combining unit 5 in FIG. 4, the sets 211 different from each other are obtained between two samples. According to the first embodiment, the sets 211 of the vectors 209 obtained from the two samples can be distinguished by subsequent processing. In addition, according to the first embodiment, the number of vectors constituting the set 211 is the same as the number of variables N (the number of columns N). On the other hand, in the technical literature [Wang22] of the comparative example, the number of vectors constituting the set 210 is the number of tokens M obtained by the token division (M≥2N). Therefore, according to the first embodiment, as compared with the comparative example, the number of vectors handled in the subsequent processing can be reduced to half or less, so that the calculation cost of the subsequent processing can be reduced.

Further, according to the first embodiment, the value may be a categorical value, and the value vector 208 may be a vector corresponding to the categorical value. In this case, even in a case where the value is a categorical value, the above-described effect can be obtained.

Furthermore, according to the first embodiment, in a case where the value is a categorical value or sentence data, the vector generation unit 4 may generate the value vector 208 that is a sentence vector by performing text analysis on the value. In this case, even in a case where the value is a categorical value or sentence data, the above-described effect can be obtained.

Further, according to the first embodiment, the value may be a numerical value, and the value vector 208 may be a vector corresponding to the numerical value. In this case, even in a case where the value is a numerical value, the above-described operation and effect can be obtained.

Furthermore, according to the first embodiment, the vector generation unit 4 may input the numerical value to the neural network to generate the value vector 208 that is an output from the neural network. In this case, in addition to the effects described above, the value vector 208 can be generated using a neural network.

Furthermore, according to the first embodiment, the vector generation unit 4 may generate the value vector 208 by linearly transforming the numerical value. In this case, the value vector 208 can be generated using a linear transformation in addition to the effects described above.

In addition, according to the first embodiment, the data/correspondence relationship acquisition unit 1 acquires the data 202 and the correspondence relationship 203 from the tabular data 201 having a plurality of variables in one sample along the row direction and each of the variables having a variable name and a value along the column direction. Therefore, since the correspondence relationship 203 used for vector combining can be acquired from the tabular data 201, it is possible to omit time and effort for the operator to input the correspondence relationship 203 in addition to the above-described effects.

Furthermore, according to the first embodiment, the vector combining unit 5 combines the variable name vector 207 and the value vector 208 using the sum of the variable name vector 207 and the value vector 208 related to the same variable name. Therefore, in addition to the effects described above, in a case where both the variable name vector 207 and the value vector 208 are D-dimensional, a combined vector 209 can be acquired as a D-dimensional vector.

Furthermore, according to the first embodiment, the vector combining unit 5 may combine the variable name vector 207 and the value vector 208 by arranging the respective elements of the variable name vector 207 and the value vector 208 relates to the same variable name. In this case, in addition to the effects described above, it is possible to reduce the load of the processing of obtaining the combined vector 209 as compared with the case of obtaining the combined vector 209 by arithmetic processing.

Furthermore, according to the first embodiment, the vector combining unit 5 may output the vector 209 obtained by combining the variable name vector 207 and the value vector 208 by inputting the variable name vector 207 and the value vector 208 related to the same variable name to a neural network. In this case, in addition to the effects described above, the combined vector 209 can be generated using the neural network.

### Modification of First Embodiment

Next, a modification of the first embodiment will be described. This modification can be similarly applied to each of the following embodiments.

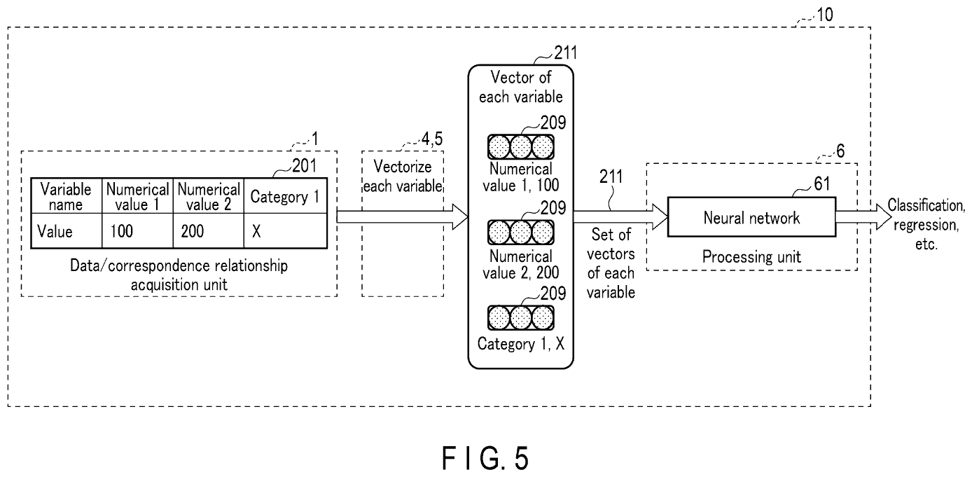

FIG. 5 is a schematic diagram for explaining a modification of the first embodiment, and the same reference numerals are given to the same constituent elements as the constituent elements described above and a detailed description thereof is omitted, and here, different portions will be mainly described. In the following embodiments, redundant description is similarly omitted.

Here, the information processing apparatus 10 further includes a processing unit 6 at a subsequent stage of the vector combining unit 5. The processing unit 6 inputs the set 211 of the vectors 209 combined by the vector combining unit 5 to a neural network 61 to perform classification processing or regression processing based on the set 211. In addition, the vector combining unit 5 outputs N number of D-dimensional vectors 209 corresponding to the respective variables. The processing unit 6 classifies and regresses the tabular data 201 as input data based on the N number of D-dimensional vectors 209 output from the vector combining unit 5.

Other configurations are the same as those of the first embodiment.

According to the modification as described above, in addition to the effects of the first embodiment, classification processing or regression processing based on the set 211 of the combined vectors 209 can be performed.

Note that, in this modification, the processing unit 6 performs feature extraction using the neural network 61 having the set 211 of vectors 209 as an input, and performs regression and classification from the obtained feature vectors. At this time, as the configuration of the neural network 61, an arbitrary number of D-dimensional vectors can be input, and input data having an arbitrary number of variables can be handled. By describing the vector generation unit 4, the vector combining unit 5, and the classification and regression processing at the subsequent stage by a differentiable operation, learning by the gradient descent method can be performed using supervised labeled training data. Furthermore, self-supervised learning without using the supervised label may be applied by the method described in the technical literature [Wang22] described above.

Note that, in a case where the neural network 61 that performs feature extraction has a multilayer structure in which the same number of D-dimensional vectors as the vectors input in the respective layers are intermediate outputs, the intermediate outputs may be interpreted as the value vectors 208 in the vector combining unit 5, and the processing in the vector combining unit 5 may be performed in the respective layers of the neural network 61.

In addition, by adopting a configuration in which the neural network 61 that performs feature extraction can process an arbitrary number of vectors, data having different variable configurations can be utilized. For example, in a manufacturing site, it is assumed that some variables are changed, added, or reduced by changing a manufacturing process, adding or reducing an inspection item, or the like. In the known technique such as Kohyo (Jpn. Unexamined Patent Application Publication) No. 2022-543393, there is a restriction that variable configurations of input data are the same, and thus data before changing the configuration cannot be utilized. However, in a case where some variable configurations are the same, the augmentation of the number of pieces of training data can be enabled using the data before changing the configuration. For example, the machine learning model may be trained using training data obtained by mixing data having different variable configurations.

Furthermore, in this modification, data having an unknown variable configuration may be input to the neural network 61 at the time of inference. However, the neural network 61 performs machine learning using data having different variable configurations as training data. Such a neural network 61 can handle combinations of variables not included in the training data with respect to the variables included in the training data among the variables included in the data having an unknown variable configuration.

### Second Embodiment

Next, an information processing apparatus according to a second embodiment will be described.

The second embodiment is a modification of the first embodiment, and represents a specific example in a case where a value associated with a variable name is a categorical value. In a case where the value is a categorical value, the value vector 208 is a vector corresponding to the categorical value.

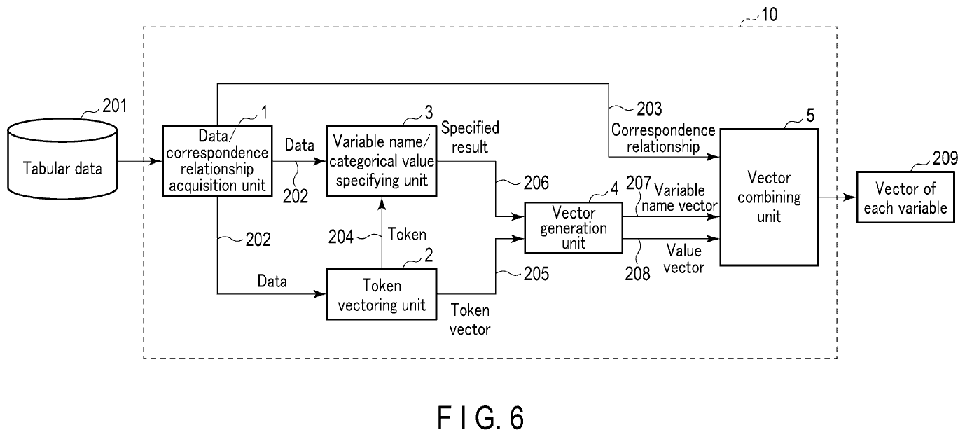

FIG. 6 is a block diagram illustrating an example of a configuration of an information processing apparatus according to the second embodiment. The information processing apparatus 10 further includes a token vectoring unit 2 and a variable name/categorical value specifying unit 3 as compared with the configuration illustrated in FIG. 1.

Here, the token vectoring unit 2 performs token division on the variable name and the categorical value for the variable including the categorical value and the variable name associated with the categorical value among the data 202 acquired by the data/correspondence relationship acquisition unit 1, and generates the token vector 205 corresponding to each obtained token 204.

The variable name/categorical value specifying unit 3 specifies a variable from which the token vector 205 is derived and a variable name or a categorical value from which the token vector 205 is derived for each token 204 obtained by the token vectoring unit 2.

Accordingly, the vector generation unit 4 generates a variable name vector 207 from the token vector 205 derived from the variable name and a value vector 208 from the token vector 205 derived from the categorical value for each variable based on the specified result 206.

For example, the vector generation unit 4 may generate the value vector 208 by processing, using the neural network, a set of token vectors 205 derived from the categorical value. In addition, the vector generation unit 4 may generate the value vector 208 by averaging the token vectors 205 derived from the categorical value.

Similarly, the vector generation unit 4 may generate the variable name vector 207 by processing, using the neural network, a set of token vectors 205 obtained from the tokens 204 constituting the variable names. In addition, the vector generation unit 4 may generate the variable name vector 207 by averaging token vectors obtained from the tokens constituting the variable name.

Other configurations are the same as those of the first embodiment.

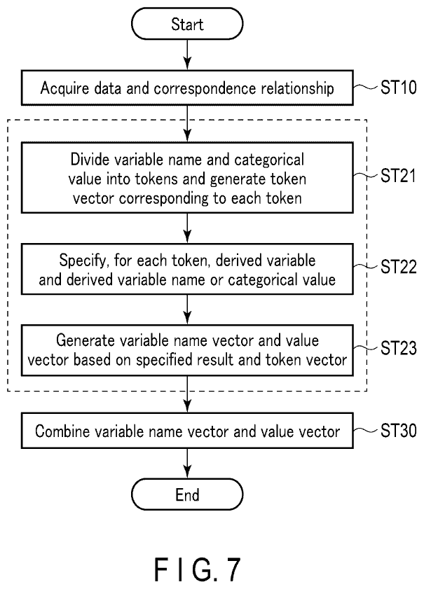

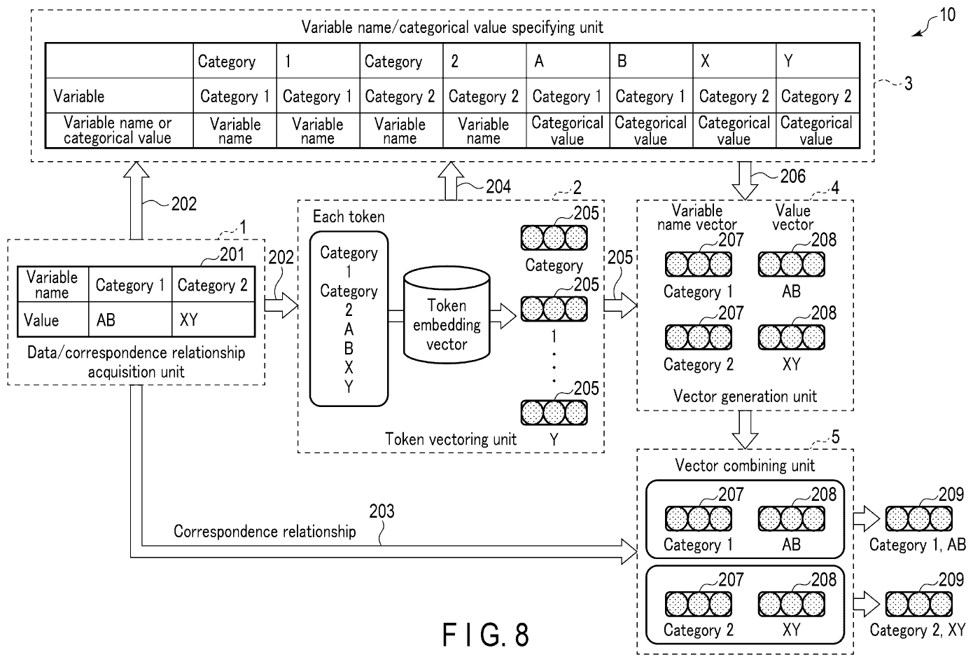

Next, the operation of the information processing apparatus configured as described above will be described with reference to the flowchart of FIG. 7 and the schematic diagram of FIG. 8. Note that steps ST21 to ST23 surrounded by broken lines in FIG. 7 are the part mainly changed from the operation illustrated in FIG. 2.

### (Step ST10: Acquisition of Data and Correspondence Relationship)

As illustrated in FIGS. 7 and 8, the data/correspondence relationship acquisition unit 1 receives input of tabular data 201. The tabular data 201 has two variables (category 1, AB) and (category 2, XY) in one sample along the row direction, and each of the variables has a variable name (column name) and a value associated with the variable name along the column direction. The values corresponding to the variable names “category 1” and “category 2” are categorical values “AB” and “XY”.

In addition, the data/correspondence relationship acquisition unit 1 acquires, from the tabular data 201, data 202 including a variable name and a value associated with the variable name, and a correspondence relationship 203 between the variable name and the value.

### (Step ST21: Token Vectorization)

The token vectoring unit 2 performs token division on the variable name and the categorical value for the variable including the categorical value and the variable name associated with the categorical value in the acquired data 202, and generates a token vector 205 corresponding to each obtained token 204. In FIG. 8, variable names are “category 1” and “category 2”. The categorical values are “AB” and “XY”. Each token 204 is “category”, “1”, “category”, “2”, “A”, “B”, “X”, and “Y”. The token vector 205 is generated by the number of tokens 204.

In other words, in step ST21, as described in the first embodiment, the variable name and the categorical value are divided into tokens, and each obtained token 204 is vectorized in units of tokens. Note that, not limited thereto, token division may be performed on the combined character string data by combining all the variable names and the categorical values of the input data into one character string data. After performing the token division, the token vectoring unit 2 converts each token 204 into a learnable token embedding vector (token vector 205). At this time, the token embedding vector may be common to the variable name and the categorical value. In addition, the token vectoring unit 2 may perform the token division process independently for each variable name and categorical value without combining into the character string data.

### (Step ST22: Identification of Variable Name and Categorical Value)

The variable name/categorical value specifying unit 3 specifies, for each token 204, a variable from which the token vector 205 is derived and a variable name or a categorical value from which the token vector 205 is derived. In addition, in a case where the token vectoring unit 2 performs token division on the character string data obtained by combining the variable name and the categorical value, it is unclear which variable each token vector 205 is related to, and which one of the variable name and the categorical value the token vector 205 is related to. On the other hand, the vector generation unit 4 in the subsequent stage generates a variable name vector 207 and a value vector 208 as vectors respectively corresponding to the variable name and the categorical value. Therefore, between the token vectoring unit 2 and the vector generation unit 4, the variable name/categorical value specifying unit 3 specifies and records which variable the token vector 205 is derived from and which of the variable name and the value the token vector 205 is derived from.

### (Step ST23: Vector Generation)

The vector generation unit 4 generates a variable name vector 207 from the token vector 205 derived from the variable name and a value vector 208 from the token vector 205 derived from the categorical value for each variable based on the result 206 specified in step ST23. As the process of generating the vector from the token vector, as described in the first embodiment, a method of processing a set of token vectors 205 by a neural network, a method of averaging the token vectors 205, and the like can be appropriately used.

### (Step ST30: Vector Combining)

Based on the correspondence relationship 203 acquired in step ST10, the vector combining unit 5 combines the variable name vector 207 and the value vector 208 generated in step ST23, and acquires the vector 209 corresponding to each variable.

As described above, according to the second embodiment, the token vectoring unit 2 divides the variable name and the categorical value of the variable including the categorical value and the variable name associated with the categorical value in the data 202 acquired by the data/correspondence relationship acquisition unit 1, and generates the token vector 205 corresponding to each obtained token 204. The variable name/categorical value specifying unit 3 specifies a variable from which the token vector 205 is derived and a variable name or a categorical value from which the token vector 205 is derived for each token 204 obtained by the token vectoring unit 2. The vector generation unit 4 generates a variable name vector 207 from the token vector 205 derived from the variable name and a value vector 208 from the token vector 205 derived from the categorical value for each variable based on the specified result 206. Therefore, in addition to the effects described above, in a case where the value associated with the variable name is a categorical value, the correspondence relationship between the variable name or the token vector 205 constituting the categorical value and the variable name or the categorical value can be clarified.

Further, according to the second embodiment, the vector generation unit 4 may generate the value vector 208 by processing a set of token vectors 205 derived from the categorical value by a neural network. In this case, in addition to the effects described above, the value vector 208 can be generated using the neural network.

In addition, according to the second embodiment, the vector generation unit 4 may generate the value vector 208 by averaging the token vector 205 derived from the categorical value. In this case, the value vector 208 can be generated using averaging in addition to the effects described above.

Further, according to the second embodiment, the vector generation unit 4 may generate the variable name vector 207 by processing a set of token vectors 205 obtained from the tokens 204 constituting the variable names by the neural network. In this case, in addition to the effects described above, the variable name vector 207 can be generated using the neural network.

Further, according to the second embodiment, the vector generation unit 4 may generate the variable name vector 207 by averaging the token vectors obtained from the tokens constituting the variable names. In this case, in addition to the effects described above, averaging can be used to generate variable name vector 207.

### Third Embodiment

Next, an information processing apparatus according to a third embodiment will be described.

The third embodiment is a modification of the first embodiment, and represents a specific example in a case where a value associated with a variable name is a numerical value. In a case where the value is a numerical value, the value vector 208 is a vector corresponding to the numerical value.

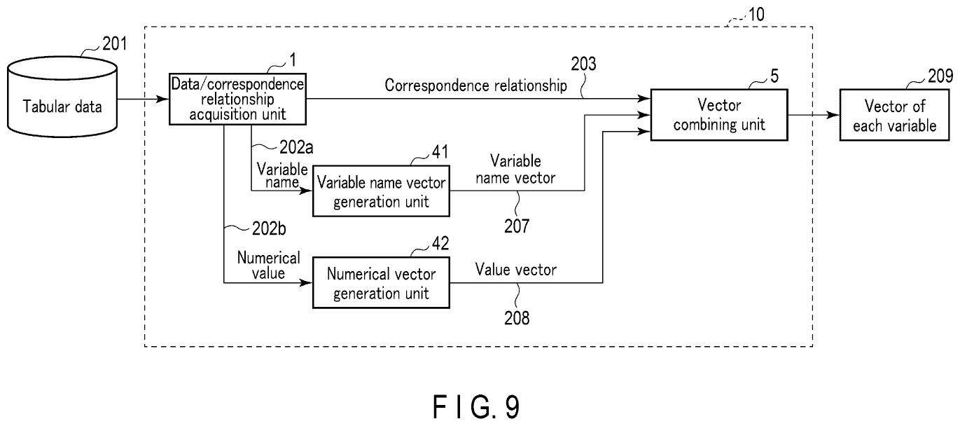

FIG. 9 is a block diagram illustrating an example of a configuration of an information processing apparatus according to the third embodiment. The information processing apparatus 10 has a configuration in which the vector generation unit 4 illustrated in FIG. 1 is divided into a variable name vector generation unit 41 and a numerical vector generation unit 42.

Here, the variable name vector generation unit 41 generates a variable name vector 207 corresponding to each variable name 202a in the data 202 including the variable name 202a and the numerical value 202b associated with the variable name 202a.

The numerical vector generation unit 42 generates a value vector 208 corresponding to the numerical value 202b corresponding to each variable name 202a in the data 202. For example, the numerical vector generation unit 42 may generate the value vector 208, which is an output of the neural network, by inputting the numerical value 202b to the neural network. Furthermore, the numerical vector generation unit 42 may generate the value vector 208 by linearly transforming the numerical value 202b. Note that, not limited thereto, the numerical vector generation unit 42 may generate the value vector 208 from the token vector 205 corresponding to the numerical value 202b by regarding the numerical value 202b as a character string, similarly to the second embodiment.

Other configurations are the same as those of the first embodiment.

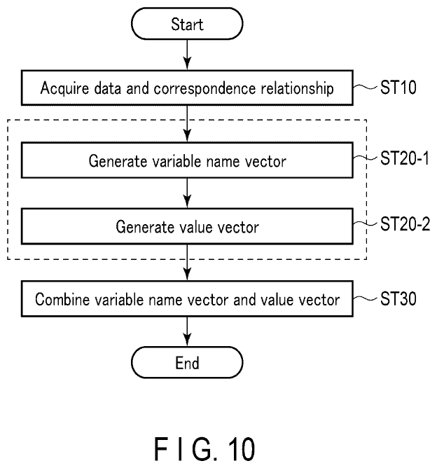

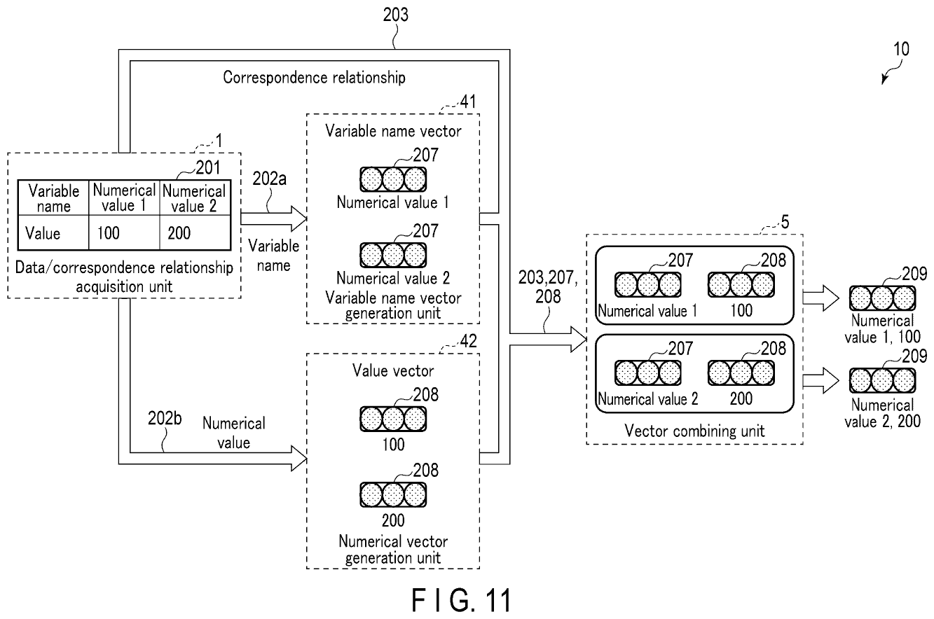

Next, the operation of the information processing apparatus configured as described above will be described with reference to the flowchart of FIG. 10 and the schematic diagram of FIG. 11. Note that steps ST20-1 and ST20-2 surrounded by broken lines in FIG. 10 are the part mainly changed from the operation illustrated in FIG. 2. In addition, any of steps ST20-1 and ST20-2 may be executed first.

### (Step ST10: Acquisition of Data and Correspondence Relationship)

As illustrated in FIGS. 10 and 11, the data/correspondence relationship acquisition unit 1 receives input of tabular data 201. In addition, the data/correspondence relationship acquisition unit 1 acquires, from the tabular data 201, the data 202 including the variable name 202a and the value associated with the variable name 202a, and the correspondence relationship 203 between the variable name 202a and the value. Here, the value corresponding to variable name 202a is numerical value 202b.

### (Step ST20-1: Generation of Variable Name Vector)

The variable name vector generation unit 41 generates a variable name vector 207 corresponding to each variable name 202a in the data 202 including the variable name 202a and the numerical value 202b associated with the variable name 202a. The process of generating the variable name vector 207 from the variable name 202a may be the method described in the first embodiment, or may be a method using the token vectoring unit 2, the variable name/categorical value specifying unit 3, and the vector generation unit 4 described in the second embodiment.

### (Step ST20-2: Generation of Numerical Vector)

The numerical vector generation unit 42 generates a value vector 208 corresponding to the numerical value 202b corresponding to each variable name 202a in the data 202. As the processing of generating the value vector 208 from the numerical value 202b, the method described in the first embodiment can be appropriately used. In addition, the process of generating the value vector 208 from the numerical value 202b may be a method using the token vectoring unit 2, the variable name/categorical value specifying unit 3, and the vector generation unit 4 described in the second embodiment by regarding the numerical value 202b as a character string.

### (Step ST30: Vector Combining)

Based on the correspondence relationship 203 acquired in step ST10, the vector combining unit 5 combines the variable name vector 207 generated in step ST20-1 and the value vector 208 generated in step ST20-2, and acquires a vector 209 corresponding to each variable.

As described above, according to the third embodiment, the variable name vector generation unit 41 generates the variable name vector 207 corresponding to each variable name 202a in the data 202 including the variable name 202a and the numerical value 202b associated with the variable name 202a. The numerical vector generation unit 42 generates a value vector 208 corresponding to the numerical value 202b corresponding to each variable name 202a in the data 202. Therefore, in addition to the effects described above, the variable name vector 207 and the value vector 208 can be generated in parallel.

### Fourth Embodiment

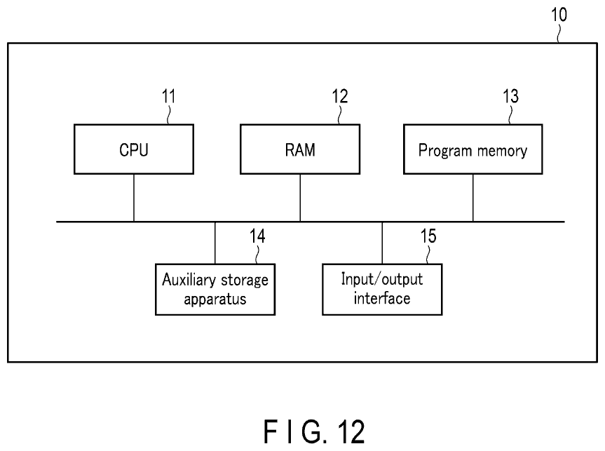

FIG. 12 is a block diagram illustrating an example of a hardware configuration of the information processing apparatus according to a fourth embodiment. The fourth embodiment is a specific example of the first to third embodiments, and has a form in which the information processing apparatus 10 is realized by a computer.

The information processing apparatus 10 includes, as hardware, a central processing unit (CPU) 11, a random access memory (RAM) 12, a program memory 13, an auxiliary storage apparatus 14, and an input/output interface 15. The CPU 11 communicates with the RAM 12, the program memory 13, the auxiliary storage apparatus 14, and the input/output interface 15 via a bus. In other words, the information processing apparatus 10 according to the present embodiment is realized by a computer having such a hardware configuration.

The CPU 11 is an example of a general-purpose processor. The RAM 12 is used as a working memory for the CPU 11. The RAM 12 includes a volatile memory such as a synchronous dynamic random access memory (SDRAM). The program memory 13 stores a program for realizing each function of each unit according to each embodiment in a computer. Furthermore, as the program memory 13, for example, a read-only memory (ROM), a part of the auxiliary storage apparatus 14, or a combination thereof is used. The auxiliary storage apparatus 14 stores data non-temporarily. The auxiliary storage apparatus 14 includes a nonvolatile memory such as a hard disc drive (HDD) or a solid state drive (SSD).

The input/output interface 15 is an interface for connecting to another device. The input/output interface 15 is used, for example, for connection with a keyboard, a mouse, and a display.

The program stored in the program memory 13 includes a computer-executable instruction. In a case where the program is executed by the CPU 11 which is processing circuitry, the program (computer-executable instruction) causes the CPU 11 to execute predetermined processing. For example, in a case where the program is executed by the CPU 11, the program causes the CPU 11 to execute a series of processes described with respect to each unit of FIGS. 1, 6, and 9. For example, the computer executable instruction included in the program causes the CPU 11 to execute the information processing method in a case of being executed by the CPU 11. The information processing method may include each step corresponding to each function of each unit described above. Furthermore, the information processing method may appropriately include the steps illustrated in FIGS. 2, 7, and 10. In place of the program, a trained model stored in the program memory 13 may be executed.

The trained model may be, for example, a model for causing a computer to function such that machine learning is performed based on multivariate data including a plurality of variable names and values associated with the variable names, and each vector obtained by combining a variable name vector corresponding to each variable name and a value vector corresponding to a value associated with each variable name with respect to the same variable name is output.

Furthermore, for example, the trained model may be a model that has undergone a machine-learning process using teacher data in which multivariate data including a plurality of variable names and values respectively associated with the variable names and a correct answer label of classification processing or an output value of regression processing based on the multivariate data are associated with each other, and the trained model may be a model for causing a computer to execute processing of receiving the multivariate data at the current time as an input and processing of outputting the correct answer label or the output value at the current time based on the received multivariate data.

Furthermore, the trained model may be, for example, a model for causing a computer to function so as to execute processing by the neural network of each of the above-described embodiments.

The program or the trained model may be provided to the information processing apparatus 10, which is a computer, in a state of being stored in a computer-readable storage medium. In this case, for example, the information processing apparatus 10 further includes a drive (not illustrated) that reads data from the storage medium, and acquires the program from the storage medium. As the storage medium, for example, a magnetic disk, an optical disk (CD-ROM, CD-R, DVD-ROM, DVD-R, and the like), a magneto-optical disk (MO and the like), a semiconductor memory, and the like can be appropriately used. The storage medium may be referred to as a non-transitory computer readable storage medium. Furthermore, the program or the trained model may be stored in a server on the communication network, and the information processing apparatus 10 may download the program or the trained model from the server using the input/output interface 15.

The processing circuitry that executes the program or the trained model is not limited to a general-purpose hardware processor such as the CPU 11, and a dedicated hardware processor such as an application specific integrated circuit (ASIC) may be used. The term processing circuitry includes at least one general purpose hardware processor, at least one special purpose hardware processor, or a combination of at least one general purpose hardware processor and at least one special purpose hardware processor. In the example illustrated in FIG. 12, the CPU 11, the RAM 12, and the program memory 13 correspond to processing circuitry.

According to at least one embodiment described above, regarding data in which a variable name and a value are associated with each other, even if a variable name is changed, added, or reduced, the data can be analyzed. The same applies to at least one modification described above.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising processing circuitry configured to:
acquire data including a variable name and a value associated with the variable name, and a correspondence relationship between the variable name and the value;
generate a variable name vector corresponding to each variable name and a value vector corresponding to the value associated with each variable name; and
combine the variable name vector and the value vector based on the correspondence relationship.

2. The information processing apparatus according to claim 1, wherein
the value is a categorical value, and
the value vector is a vector corresponding to the categorical value.

3. The information processing apparatus according to claim 2, wherein the processing circuitry is configured to:
perform token division on the variable name and the categorical value for a variable including the categorical value and the variable name associated with the categorical value among the acquired data, and generate a token vector corresponding to each obtained token;
specify, for each token, the variable from which the token vector is derived and the variable name or the categorical value from which the token vector is derived; and
generate the variable name vector from the token vector derived from the variable name and generate the value vector from the token vector derived from the categorical value for each variable based on the specified result.

4. The information processing apparatus according to claim 3, wherein the processing circuitry is configured to generate the value vector by processing, using a neural network, a set of token vectors derived from the categorical value.

5. The information processing apparatus according to claim 3, wherein the processing circuitry is configured to generate the value vector by averaging the token vectors derived from the categorical value.

6. The information processing apparatus according to claim 1, wherein the processing circuitry is configured to generate the value vector that is a sentence vector by performing text analysis on the value in a case where the value is a categorical value or sentence data.

7. The information processing apparatus according to claim 1, wherein
the value is a numerical value, and
the value vector is a vector corresponding to the numerical value.

8. The information processing apparatus according to claim 7, wherein the processing circuitry is configured to input the numerical value to a neural network and generate the value vector that is an output from the neural network.

9. The information processing apparatus according to claim 7, wherein the processing circuitry is configured to generate the value vector by linearly transforming the numerical value.

10. The information processing apparatus according to claim 1, wherein the processing circuitry is configured to acquire the data and the correspondence relationship from tabular data having a plurality of variables in a sample along a row direction, each of the variables having the variable name and the value along a column direction.

11. The information processing apparatus according to claim 1, wherein the processing circuitry is configured to generate the variable name vector by processing, using a neural network, a set of token vectors obtained from tokens constituting the variable name.

12. The information processing apparatus according to claim 1, wherein the processing circuitry is configured to generate the variable name vector by averaging token vectors obtained from tokens constituting the variable names.

13. The information processing apparatus according to claim 1, wherein the processing circuitry is configured to combine the variable name vector and the value vector using a sum of the variable name vector and the value vector related to an identical variable name.

14. The information processing apparatus according to claim 1, wherein the processing circuitry is configured to combine the variable name vector and the value vector by arranging respective elements of the variable name vector and the value vector related to an identical variable name.

15. The information processing apparatus according to claim 1, wherein the processing circuitry is configured to output a vector obtained by combining the variable name vector and the value vector by inputting, to a neural network, the variable name vector and the value vector related to an identical variable name.

16. The information processing apparatus according to claim 1, wherein the processing circuitry is further configured to input a set of the combined vectors to a neural network to perform classification processing or regression processing based on the set.

17. An information processing method comprising:
acquiring, by processing circuitry, data including a variable name and a value associated with the variable name, and a correspondence relationship between the variable name and the value;
generating, by the processing circuitry, a variable name vector corresponding to each variable name and a value vector corresponding to the value associated with each variable name; and
combining, by the processing circuitry, the variable name vector and the value vector based on the correspondence relationship.

18. A non-transitory computer readable storage medium including computer executable instructions, wherein the instructions, when executed by a processor, cause the processor to perform a method comprising:
acquiring data including a variable name and a value associated with the variable name, and a correspondence relationship between the variable name and the value;
generating a variable name vector corresponding to each variable name and a value vector corresponding to the value associated with each variable name; and
combining the variable name vector and the value vector based on the correspondence relationship.
